(19) United States
(12) Patent Application Publication
(10) Pub. No.: US 2007/0272305 A1
(43) Pub. Date: Nov. 29, 2007

(54) IRRIGATION SYSTEM VALVE MANIFOLD VAULT

(76) Inventor: Scott Schumacher, Kelseyville, CA (US)

Correspondence Address: STAINBROOK & STAINBROOK, LLP, 412 AVIATION BOULEVARD, SUITE H, SANTA ROSA, CA, 95403, US

(21) Appl. No.: 11/752,763

(22) Filed: May 23, 2007

Related U.S. Application Data
(60) Provisional application No. 60/803,005, filed on May 23, 2006.

(51) Int. Cl. F16K 27/08

(52) U.S. Cl. 137/382

(57) ABSTRACT

A valve manifold vault, lid, and vault support base for subsurface irrigation system valve manifolds. The vault, lid, and support base provide a secure enclosure that prevents movement of a valve assembly and protects valves and valve components.

### CROSS REFERENCE TO RELATED APPLICATIONS

The present application claims the benefit of U.S. Provisional Patent Application Ser. No. 60/803,005, filed May 23, 2006.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to irrigation system apparatus, and more particularly to irrigation system valve manifolds, and still more particularly to an irrigation system valve manifold enclosure for subsurface installation and protection of an electronically powered irrigation system valve manifold.

### BACKGROUND INFORMATION AND DISCUSSION OF RELATED ART

Discussion of Related Art including information disclosed under 37 CFR §§1.97, 1.98: Irrigation system pipes are customarily buried below ground in order to protect the pipes from mechanical and weather related damage, to clear space for the free movement of foot and vehicular traffic, and eliminate unsightly apparatus from otherwise aesthetic environments. Valves and valve manifolds commonly employed to control automatic irrigation systems are also frequently buried, generally for the same reasons. The preferred method of burying an irrigation valve manifolds entails providing an enclosure or box for placement in a hole, wholly or partially burying the enclosure, constructing the manifold within the enclosure and connecting it to pipes running to the irrigation areas, and coupling the manifold to a water supply line with a union. In most residential applications, the valve box is left with a portion above ground level, to provide easier access. An electronic valve controller is installed, typically on or in a nearby structure, with leads to each valve passing through a hole into the enclosure interior.

Irrigation system valve manifold boxes are known in the art. The industry leader by a considerable margin is Rain Bird Corporation of Azusa/Glendora, Calif. Valve boxes manufactured by this company typically include a rigid rectangular enclosure for valve system components manufactured from foam high density polyethylene (HDPE) resin, knock-outs for running pipes and wires into the box interior, and a removable lid. Some models provide connection structure to facilitate mounting one box atop another valve box for deep installations. However, none of the Rain Bird boxes includes structure for pre-mounting a valve manifold and/or valve manifold pipe assembly, which must be constructed and installed independently and then fit into the box.

Most of the known valve boxes provide insufficient protection of the valve assembly from water intrusion, insects, migrating soils, and so on. Additionally, the valve manifold assemblies generally remain unsupported within the enclosure, and special apparatus or connectors must therefore be installed on the valve box or other structure provided in order to secure, stabilize, and protect the assembly from movement and damage.

A few solutions to the foregoing problems have been proposed and are known. These include, as examples, U.S. Pat. No. 3,984,023, to Hodas, which shows a plastic cuboid underground valve box including separate side and end walls that include interlocking portions adjacent their edges that secure them to each other during assembly of the box. The bottom side of the box is open to permit positioning of the box over one or more underground valves. A plastic cover is pivoted to the box so as to control access to the valve or valves within the box. The box may be divided into one or more compartments that each receive an associated valve.

U.S. Pat. No. 4,976,366, to Russell, shows an underground valve box having a tubular base divided into upper and lower portions by a horizontal member. Concentric steps descend downwardly and inwardly from the horizontal member into the lower portion of the base forming a series of seats, decreasing in diameter and increasing in depth, one of which will accommodate the selected valve body. The upper portion of the base has a pair of topwardly accessible diametrically opposed notches in which the inlet and outlet lines of the valve will be disposed when the valve body is inserted in its appropriate seat. The valve box also includes a tubular body which has a pair of bottomwardly accessible notches which can be aligned with the topwardly accessible notches of the tubular base. The tubular body is configured to securely removably gird the upper portion of the tubular base with the inlet and outlet lines of the valve disposed in the bottomwardly accessible notches. Preferably, the tubular body is contoured to also restrictively receive the body of the valve so as to minimize the possibility of rotation of the valve within the box.

U.S. Pat. No. 4,872,575, to Kobilan, teaches a protective housing for underground devices, including valves. It includes a base assembly with an open bottom and open top which may be closed with a snap-fit lid, but constructed for stackable arrangement of a plurality of housing structures. The sidewalls and endwalls are constructed to facilitate incisions, slots, and removable flap.

The foregoing patents and prior art devices reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is an irrigation system valve manifold vault for subsurface installation and maintenance. The inventive apparatus provides a secure enclosure to prevent migration of the vault within and along the ground and that protects irrigation valves and valve components from water, contamination by dirt and debris, chemical damage from soils, insect infestation, and damage from impact and weather. In a first preferred embodiment, the inventive apparatus comprises a generally rectangular support base, a vault truncated, four-side pyramidal vault enclosure mounted on the support base, an openable lid removably or attached by hinges to the top of the vault enclosure for access to the interior in which a valve manifold is contained, and attachment means for mounting a water supply pipe or other component of the valve assembly onto the side or top surface of the support base.

In most instances, the above-described apparatus will be installed slightly below grade, such that the top surface of the support base is essentially at grade or ground level. The vault enclosure is then mounted onto the top of the support base, either permanently with secure fasteners, or pivotally, as with hinges. In this manner, the entire vault enclosure can be tipped, if necessary, for maintenance and servicing. Knockouts proximate the lower portion of the vault enclosure may permit pipes (e.g., a water supply pipe) to be passed through the side of the vault enclosure without interfering with the hinged pivoting of the vault enclosure on the support base.

Accordingly, it is a first and principal object of the present invention to provide a novel irrigation system valve manifold cover that encloses a valve assembly in an easily accessible vault.

Yet another object of the present invention is to provide an irrigation system valve manifold cover that protects irrigation system valves from water intrusion, insects, and migrating soils.

Still another object is to provide a valve manifold assembly base and vault combination that secures, stabilizes, and protects the valve assembly from movement and damage from impact.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an upper left perspective view showing the irrigation system manifold vault of the present invention;

FIG. 2 is an exploded upper left perspective view showing the structural elements of the irrigation system valve manifold vault of FIG. 1;

FIG. 3 is an upper left perspective view showing a valve manifold installed and mounted on the base portion of the valve manifold vault, shown without the vault top enclosure;

FIG. 4 is a cross-sectional front side view in elevation showing a valve manifold and valves mounted on the base portion and covered with the vault top enclosure;

FIG. 5A is a cross-sectional left end view in elevation shown along section line 5A of FIG. 1 showing the vault top enclosure lid closed and bolted shut; and

FIG. 5B is a cross-sectional end view in elevation showing the vault top enclosure with the lid open and the valve assembly removed.

### DETAILED DESCRIPTION OF THE INVENTION

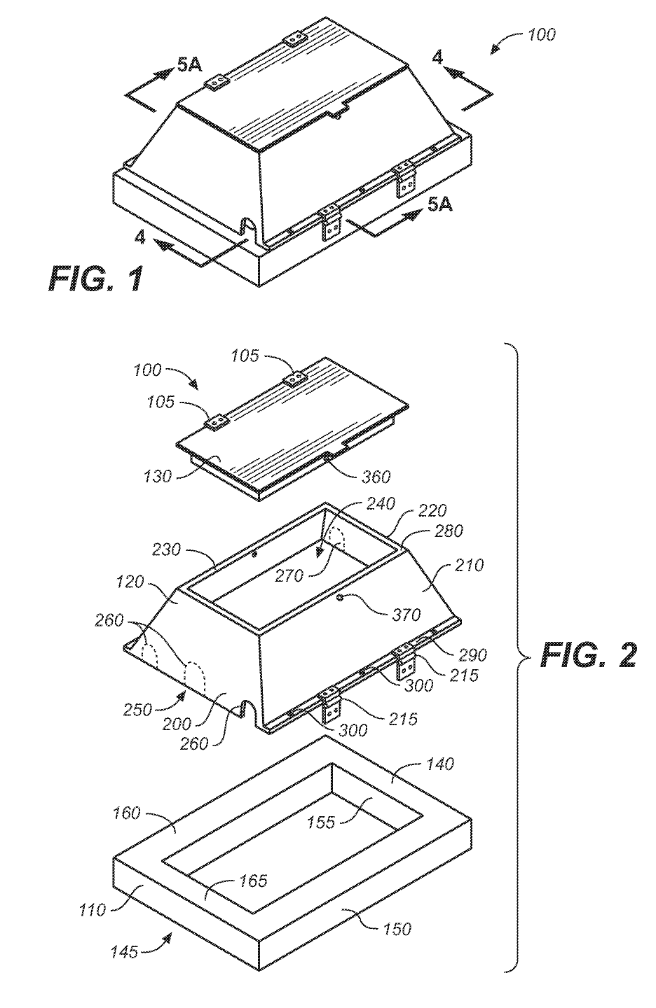

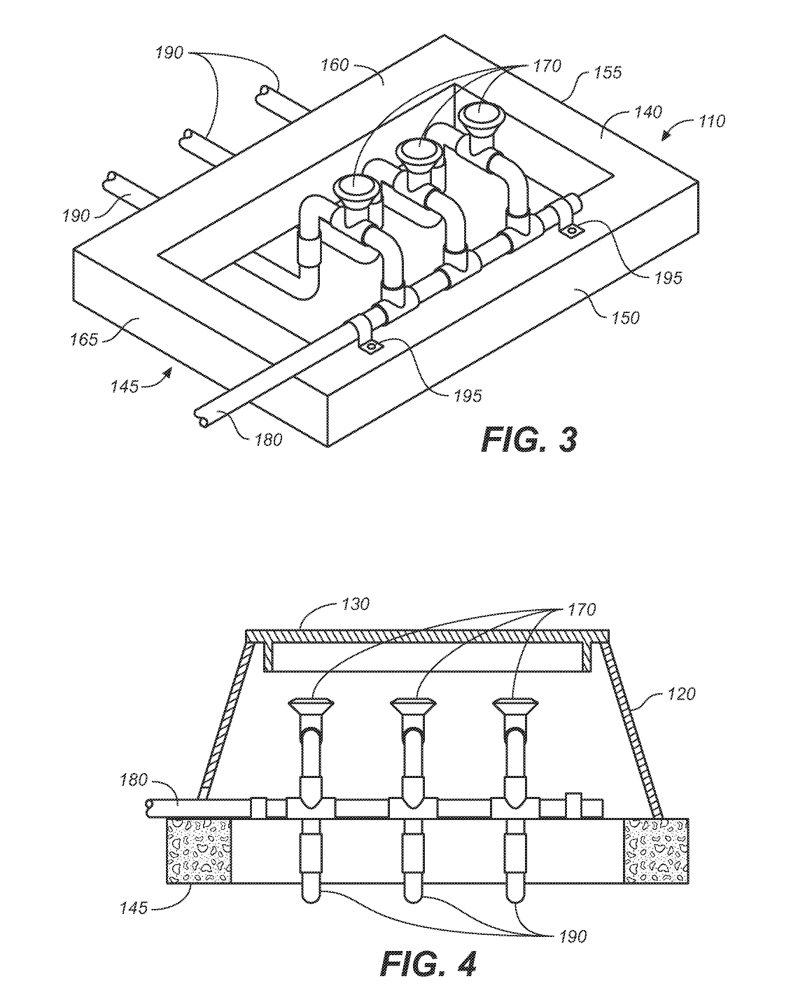

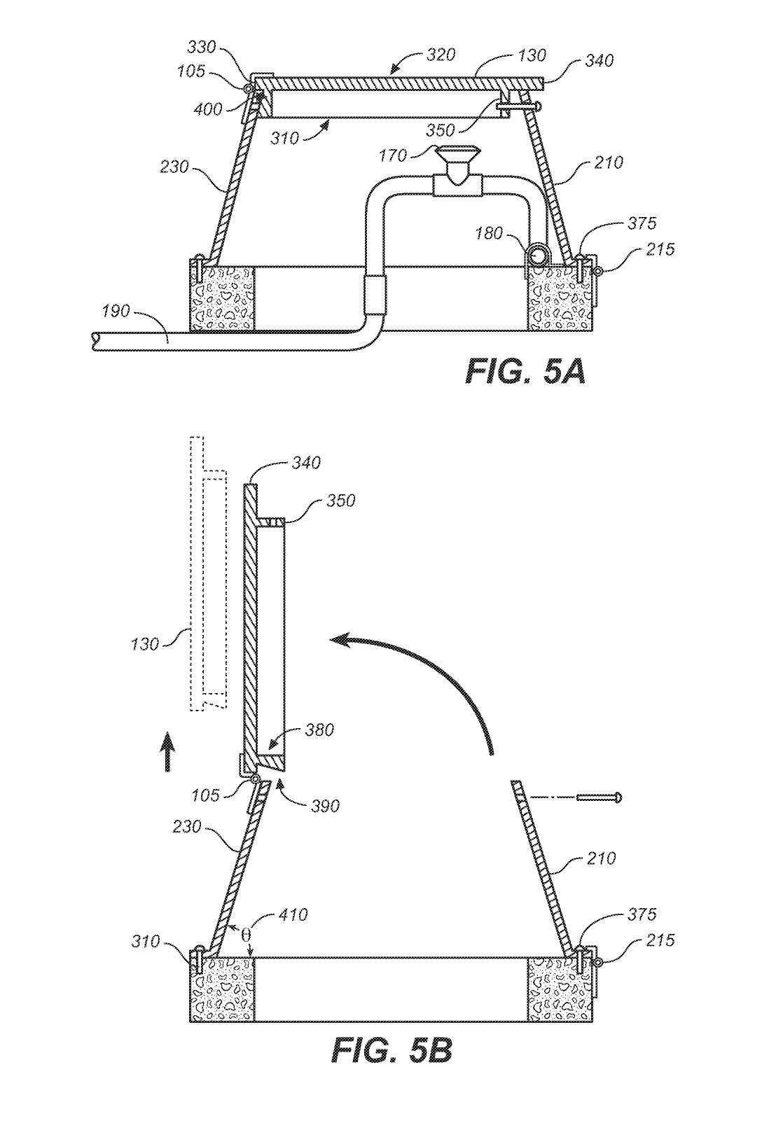

Referring to FIGS. 1 through 5B, wherein like reference numerals refer to like components in the various views, there is illustrated therein a new and improved irrigation system valve manifold vault, generally denominated 100 herein. These views, collectively, show that the inventive apparatus comprises three primary portions, including a support base 110, a vault enclosure 120, and a lid 130.

The support frame, or support base, 110 is generally configured in a solid rectangular frame conformation and has sufficient mass to support and secure valve manifolds of the kind typically installed in underground enclosures. It includes four frame members, including a front side 150, a right side 155, a back side 160, and a left side 165. The front, rear, right and left sides are joined to form a contiguous and substantially co-planar top side 140 and a contiguous and co-planar bottom side 145.

A plurality of valves 170 may then be configured into a valve manifold assembly with conventional connectors, elbows, Ts, and the like, in which the valve is connected to a water supply pipe 180 in the inlet end of the valve and to a plurality of corresponding irrigation pipes at the outlet end of the valve. The assembly can then be mounted onto the top side 140 of the base 110 using pipe U-brackets 195, in a well known manner. It will be appreciated that the material from which the support base is made is sufficiently dense for the effective use of screws as fasteners, though bolts could be employed when the base is fabricated from lightweight and less sturdy materials. Additionally, it will be appreciated that the water supply pipe could enter the enclosure from underneath the support base, or even through a side of the support base (there being a through hole provided for such an insertion), and the supply could also be mounted to an interior side of the base, rather than to the top side. However, such a configuration does not alter the fundamental structural and operational characteristics of the present invention.

The vault enclosure 120 is shaped as a truncated, four-sided pyramid and comprises a left side 200, a front side 210, a right side 220, and a back side 230. The sides are joined at their respective edges to adjoining sides and angle inwardly toward their upper portions to form an open top 240, which functions as an access to valve components. The bottom 250 is also open. Knockouts, 260 and 270, are included on each of the left and right sides, respectively, to provide means to insert inlet pipes through a selected side. The sides terminate at their upper portions in an upper edge 280, which provides a seat for lid 130.

The bottom portion of the front and back sides, includes a flange 290 having a plurality of holes 300 for securing the vault enclosure proximate the perimeter of the base with fasteners 305 onto the top side of the support base. Alternatively, the vault enclosure may be pivotally attached to one side of the support base with hinges 215, and then attached to the other side of the support base with permanent fasteners or selectively releasable fasteners, such as cotter pins, clevis pins, or simply a conventional latch. The angle 410 between the front and back sides of the vault enclosure and the top side of the support base can be adjusted for the typical commercial and residential installations such that there is sufficient clearance between the interior walls of the vault enclosure and the valve body to prevent any bending or twisting applied to the enclosed conduits or pressure applied to the valve body.

The lid 130 includes an underside 310 and a top side 320, a back edge 330 and a front edge 340. A downwardly projecting skirt extends substantially around the underside of the lid, though it is spaced apart from the edge of the underside such that it fits within the opening in the vault. The front side 350 of the skirt includes a through hole 360 that may be aligned with a through hole 370 in the front side of the vault enclosure for securing with a pin 375.

The back side 380 of the skirt includes an angled side 400 that matches the angle of the interior side of the back side 230 of the vault enclosure. This secures the lid snugly onto the top of the vault enclosure while facilitating easy removal for adjustment, replacement, and repair of the valves. Alternatively, the lid may be pivotally attached to the vault enclosure by hinges 105 and secured in its shut position with pin 375, as described above.

As will be appreciated, a fundamental objective achieved by the lid and vault enclosure assembly is to provide rapid access to a clean and well-preserved valve manifold. Underground valve manifolds are notoriously dirty, rusted, bug and spider infested, and frequently submerged under ground water. The lid and vault enclosure combination described herein overcomes these problems by protectively covering a manifold secured on a buried support with a sarcophagus-like structure that extends above ground and above low levels of vegetation or snow. When placed on crushed rock or pea gravel, the support prevents a measure of water intrusion and further prevents infestation by spiders.

From the foregoing description, it will be clear that in its most essential aspect, the present invention is an irrigation system valve manifold vault which includes, at a minimum: a support base, a vault enclosure mounted on the support base, wherein the vault enclosure is a truncated four-sided pyramid having an open top, an open bottom, and four sides; an openable lid which selectively covers the open top of the vault enclosure and providing selective access to the interior of said enclosure; and bracket or other structural means for attaching an irrigation valve manifold assembly onto the support base.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An irrigation system valve manifold vault, comprising:
a support base;
a vault enclosure mounted on said support base, said vault enclosure being a truncated four-sided pyramid having an open top, an open bottom, and four sides;
a lid selectively covering the open top of said vault enclosure and providing selective access to the interior of said enclosure; and
support base attachment means for attaching an irrigation valve manifold assembly to said support base.

2. The apparatus of claim 1, wherein said lid is removably mounted on said vault enclosure.

3. The apparatus of claim 1, wherein said lid is pivotally mounted on said vault enclosure.

4. The apparatus of claim 3, where said lid is mounted on said vault enclosure with one or more hinges.

5. The apparatus of claim 1, wherein said support base is a solid rectangular frame.

6. The apparatus of claim 1, wherein said support base attachment means comprises one or more U-brackets for connecting an irrigation valve manifold assembly water supply pipe to said support base.

7. The apparatus of claim 1, wherein said vault enclosure is affixed to said support base.

8. The apparatus of claim 1, wherein said vault enclosure is pivotally attached to said support base.

9. The apparatus of claim 8, wherein said vault enclosure is attached to said support base with one or more hinges.

10. The apparatus of claim 1, wherein said vault enclosure includes knockouts for insertion of a water supply pipe through said vault enclosure in a selected side.

11. The apparatus of claim 1, wherein said lid includes an underside and a top side, a back edge and a front edge, and a downwardly projecting skirt extending substantially around said underside and being spaced apart from the edge of the underside so as to within the open top of said vault enclosure when mounted in said vault enclosure, said skirt having a front side that includes a through hole that may be aligned with a through hole in the front side of said vault enclosure for the insertion of a pin.

12. The apparatus of claim 11, wherein said vault enclosure includes an angled back side having an interior side and said skirt includes an angled back side that matches the angle of said interior side of said back side.

13. An enclosure for a valve manifold, comprising:
a generally rectangular support frame having four frame members and four interior side surfaces;
a vault enclosure mounted on said support frame, said vault enclosure having a plurality of inwardly angling sides, an open top, and an open bottom;
a vault lid for providing selective access to the interior of said vault enclosure; and
valve manifold attachment means for attaching a valve manifold assembly to said support frame.

14. The apparatus of claim 13, wherein said vault enclosure has four sides.

15. The apparatus of claim 13, wherein said vault enclosure includes knockouts providing passages for the insertion of pipes through said vault enclosure.

16. The apparatus of claim 13, wherein said valve manifold attachment means is disposed on said upper surface of said support frame.

17. The apparatus of claim 13, wherein said valve manifold attachment means is disposed on at least one of said four interior sides of said support frame.

18. The apparatus of claim 13, wherein four frame members, including a front side, a right side, a back side, and a left side, and wherein said frame members are joined to form a contiguous and substantially co-planar top side and a contiguous and substantially co-planar bottom side.
